(19) United States
(12) Patent Application Publication
(10) Pub. No.: US 2002/0086566 A1
(43) Pub. Date: Jul. 4, 2002

(54) Robust, low-resistance elastomeric conductive polymer interconnect

(76) Inventor: Everett F. Simons, Mansfield, MA (US)

Correspondence Address: MIRICK O'CONNELL, 1700 WEST PARK DRIVE, WESTBOROUGH, MA, 01581-3941, US

(21) Appl. No.: 10/010,775

(22) Filed: Dec. 6, 2001

Related U.S. Application Data
(60) Provisional application No. 60/251,320, filed on Dec. 6, 2000.

(51) Int. Cl. H01R 4/58; B23K 1/19; B23K 20/16; B23K 20/22; B23K 35/24; B23K 35/36

(52) U.S. Cl. 439/86; 228/262.9

(57) ABSTRACT

An elastomeric device for electrically interconnecting two or more components, and a method for making the device. The device comprises an elastomeric matrix having one or more outer surfaces, and one or more electrically conductive pathways through the matrix, wherein at least a portion of the electrical pathway contains a material that is an electrically conductive liquid at the elastomeric device's operating temperature.

### BACKGROUND OF THE INVENTION

Elastomeric Conductive Polymer Interconnect (ECPI) is a composite of conductive metal particles in an elastomeric matrix that is normally constructed such that it conducts along one axis only. In general this type of material is made to conduct through its thickness. Anisotropic conductivity is achieved by mixing magnetic particles with a liquid resin, forming the mix into a continuous sheet and curing the sheet in the presence of a magnetic field. This results in the particles forming electrically conductive columns through the sheet thickness.

Silver coated nickel particles are typically mixed into a two-part heat curable silicone resin. The resin is coated onto a carrier sheet and pulled into a magnetic oven. The vertical magnetic field causes the particles to form into vertical columns that may protrude above the resin surface. The silicone resin then polymerizes, mechanically locking the particles into position. The carrier is then removed from the magnetic oven, and is typically heated further in a post-cure, to eliminate any remaining volatile or reactive components. The result is an elastomeric conductive particle interconnect (ECPI). In use, an electrical device would be mechanically pressed against a corresponding substrate (e.g. circuit board), with a layer of ECPI sandwiched between them.

Anisotropically conductive sheets have many particle columns per pad, so that the electrical connection is not substantially compromised by the failure of one particle or column. Decreasing particle size allows narrower and more closely spaced columns, increasing the number of conductive paths per pad, thus making the system more homogeneous and robust. However, each electrically conductive column has multiple particles, and each particle interface adds to the electrical resistance of the connection. Since the particles are touching but not bonded to each other, these interfaces are also potential failure sites during thermal or mechanical changes.

### SUMMARY AND DETAILED DESCRIPTION OF THE INVENTION

The device and methods of the invention provide unique improvements to anisotropic conductive elastomers, and more specifically to ECPIs, which enhance performance and reliability and broaden their range of applications. These improvements occur in one aspect of the invention by using electrically conductive liquid to reduce the electrical and thermal resistance of the conductive columns. Unlike previously used ECPIs, the devices and methods of the invention utilize a liquid conductor to reduce the interface resistance between particles within the columns, and to reduce the variation of the column resistance due to motion of the column and/or matrix material, e.g. due to mechanical vibration or thermal cycling. Alternatively, a substantial fraction of each electrical (and thermal) pathway can be solely liquid.

The invention can also provide additional surface features in the ECPI, including one or more contact pads, which protect the underlying conductive particles and improve conductivity between the device and the opposing components.

In one embodiment, the invention features a conductor that is a liquid over at least the upper range of the temperatures at which the device is intended to be used. Since the liquid can not impart significant mechanical force to the devices being interconnected, it allows the devices to thermally expand and contract without creating mechanical stresses on the joints. A liquid metal interconnect also makes the system more robust with respect to certain other adverse conditions, such as shock or vibration.

Alloys are available that would melt below the devices' typical temperature of use. For example, Gallium melts at 30 C., an alloy of In(51%)Bi(32.5%)Sn(16.5%) melts at 60.5 C., In(67%)Bi(33%) melts at 70 C., and Bi(58%)Sn(42%) melts at 140 C. If the particle columns are captive at the ECPI surfaces, e.g. by use of external plated pads, then the entire middle layer of the ECPI in this case would be extremely compliant.

Compared to a traditional solder joint, the liquid metal ECPI accommodates more lateral displacement (e.g. from differential thermal expansion) while creating less reaction force. Compared to previous formulations of ECPI, the column resistance is also substantially reduced.

With liquid metal ECPI encapsulated by external pads, it would be possible to solder the ECPI to the substrate and to the device. Soldering the three together would allow the sandwich to be freestanding, i.e. would require no external mechanical compression as is traditional ECPI.

In another embodiment, this invention features magnetic particles coated with a fusible material before they are mixed into the resin. The particle columns could then either be fused during magnetic alignment, or fused afterwards during the post-cure, depending upon the choice of fusible alloy and the selected polymerization and post-cure temperatures. The conductive paths would in this case contain both solid magnetic particles and liquid phase conductor. Electrical conductivity of the magnetic particles would in this case be preferred but not required.

A preferred embodiment of the elastomeric device of the invention for electrically interconnecting two or more components, comprises: an elastomeric matrix having one or more outer surfaces; one or more electrically conductive pathways through the matrix, wherein at least a portion of one or more pathways contains a material that is an electrically conductive liquid over at least part of the range of the device's use temperature; and one or more electrically conductive contact pads, wherein at least a portion of one or more of the pads is flush with or extends outward from one or more of the outer surfaces of the matrix, and wherein at least a portion of the pad is in electrical contact with one or more of the pathways. The matrix preferably comprises one or more elastomers which retains most of its elasticity over a temperature range of between about 20° C. to 75° C.

The anisotropic pathways preferably comprise between about 2 to 50% magnetic particles by volume of the elastomeric matrix; wherein a plurality of the magnetic particles are preferably aligned to form one or more arrays of electrically isolated columns having at least one end, and wherein one or more of the pads is in contact with an end of one or more of the columns of particles. In a device wherein one or more of the pathways comprises a plurality of particles aligned to form a column having at least one end and wherein one or more of the pathways is isotropic, one or more of the pads is preferably in contact with at least one of the ends of one or more of the columns of particles.

In applications wherein at least one of the components is a circuit board comprising an array of electrical contact points (lands), the array of pads preferably corresponds to the array of contact points on the board. In applications wherein at least one of the components is a heat sink, the pathways are anisotropic and are oriented to conduct in a direction from the circuit board to the heat sink. In applications wherein at least one of the components is a ball grid array comprising an array of conductive balls, the array of pads preferably corresponds to the array of conductive balls.

The device of the invention may further comprise one or more support components. At least one of the support components may be a carrier sheet. One or more of the components may comprise registration holes. At least one of the support components may contain one or more registration holes which correspond to the registration holes of the component and through which one or more precision pins may be passed. At least one of the support components may comprise one or more mounting holes which are at least partially filled with the elastomeric matrix. One of the support components may be a removable film that will preferably leave behind spaces between two or more of the pads into which at least a portion of the matrix may expand when the matrix is compressed.

The preferred method of the invention, for making an elastomeric device for electrically interconnecting two or more components, comprises the steps of: embedding a plurality of magnetic particles, coated with a low melting point metal or alloy, in an elastomer which retains most of its elasticity over a temperature range of at least 0° C. to 75° C. by mixing the particles in the elastomer before the elastomer sets; coating the elastomer/particle mixture onto a carrier sheet, which may include an electrically conductive layer or an array of electrically conductive pads; applying a magnetic field so that the particles align themselves in electrically isolated columns; heating the matrix sufficiently to fuse the low melting point alloy coating; and polymerizing the elastomer to form an elastomeric matrix having one or more outer surfaces and comprising one or more electrically conductive pathways through the matrix. The method may further comprise the step of applying an additional layer of electrically conductive pads to the side of the elastomeric matrix sheet opposite that of the carrier sheet.

The step of applying an additional layer of electrically conductive pads to the elastomeric matrix sheet opposite that of the carrier sheet may be accomplished by preparing and plating a metal layer or layers onto the ECPI sheet, then etching an array of pads.

The pathways used in the method of the invention are preferably anisotropic and may comprise between about 2 to 50% magnetic particles by volume of the elastomeric matrix, wherein a plurality of the columns of magnetic particles have at least one end particle proximate to one or more of the outer surface of the matrix, and wherein one or more of the pads is in intimate contact with an end particle of one or more of the columns of particles.

This invention also contemplates variations on the liquid metal interconnect. For example, rather than creating an independent sheet of liquid metal ECPI of the invention and then using it to connect two devices (e.g. a silicon chip connected to an interposer) using compression or soldering, the same type of lateral compliance can be obtained by forming the liquid metal ECPI as an integral part of a device/ECPI/device sandwich, as follows. Apply an array of low melting point fusible bumps on one device. A corresponding array of pads would exist on the device to be mated. The second array could be metal pads also with low melting point bumps, or a higher melting point ball or bump. The arrays would be placed together and the interconnections fused, and could then be cooled and solidified. A dielectric underfill, e.g. silicone resin, would then be applied and polymerized to individually encapsulate the interconnections. Alternatively, the silicone resin could be applied over one or both arrays on the devices before they were bonded together, then polymerized during or after the bumps fused into electrical interconnections. In either case, the polymerized resin would become the mechanical attachment between the devices, e.g. a printed circuit board and a ceramic chip carrier.

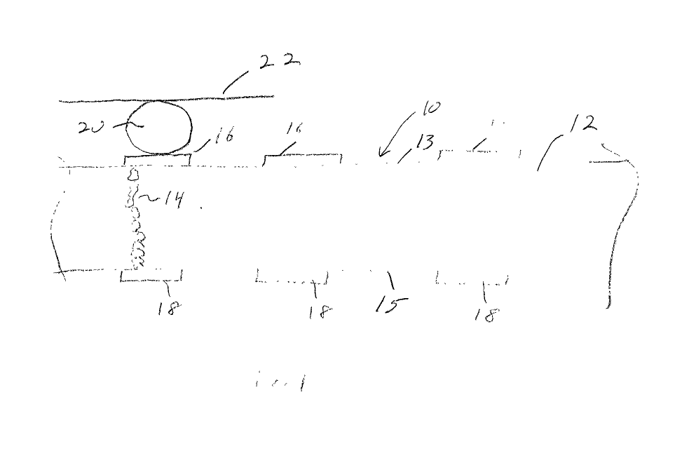

Other objects, features and advantages will occur to those skilled in the art from the following summary and description of the preferred embodiment, and the accompanying drawing, FIG. 1, which is a highly schematic diagram of an ECPI of this invention.

FIG. 1 depicts in highly schematic fashion ECPI device 10 according to this invention. Device 10 includes elastomeric matrix 12 having outer surfaces 13 and 15, and electrically conductive pathways 14 through matrix 12. For purposes of illustration only, only one conductive pathway 14 is depicted, although in practice there would be many such pathways distributed roughly in parallel across the thickness of matrix 12 as shown by the one column in the drawing. In accordance with the invention, some or all of pathway 14 comprises a material that is an electrically conductive liquid at the operating temperature of device 10. This feature can be accomplished with a material that is liquid at the device operating temperature or by a coating on particles in which the coating rather than the particles is liquid at the operating temperature.

Other features are shown in FIG. 1. There can be electrically conductive pads 16 and 18 on one or both surfaces of matrix 12, in which the ends of at least one column need to be in conductive communication with the pads to establish electrical contact from surface 13 to surface 15. When the invention is used to dissipate heat, such pads are not necessary.

Also schematically depicted in FIG. 1 is a sense of the uses of ECPI material. In this case, device (for example a chip or a board) 22 is electrically connected to pad 16 using solder ball 20. This is exemplary only to show one manner in which the ECPI of this invention can be used as an interconnect. Obviously, pads 18 would be connected to another device, which is not shown because this interconnection per se is not a feature of the invention.

The conductive pads can be put on after the ECPI is made, for example by plating or deposition, and etching. Alternatively, the pads can be placed on the carrier on which the ECPI is formed so that the pads are bonded to the ECPI during the ECPI creation process.

The inventive product can also be created by creating an array of low melting point metallic columns on a carrier and laterally encapsulating the array in an electrically isolating elastomeric matrix. Alternatively, an array of openings may be created in the electrically isolating elastomeric matrix, and these openings then filled with a material that is an electrically conductive liquid over at least the upper range of the use temperature of the device.

Various features of the invention are not shown in the drawing, but would be readily understood by those skilled in the art.

What is claimed is:

1. An elastomeric device for electrically interconnecting two or more components, comprising,
an elastomeric matrix having one or more outer surfaces; and
one or more electrically conductive pathways through said matrix, wherein at least a portion of the electrical pathway contains a material that is an electrically conductive liquid at the elastomeric device's operating temperature.

2. The device of claim 1, further comprising one or more electrically conductive contact pads, wherein at least a portion of said pad is in electrical contact with one or more of said pathways.

3. The device of claim 1, wherein the electrically conductive liquid is a low melting point metal or alloy.

4. The device of claim 3, wherein said metal is Gallium.

5. The device of claim 3, wherein said alloy contains one or more metals selected from the group of metals consisting of Gallium, Indium, Bismuth, and Tin.

6. The device of claim 1, wherein said pathways are anisotropic and comprise between about 2 to 50% magnetic particles by volume of said elastomeric matrix.

7. The device of claim 1, wherein said matrix comprises one or more elastomers which retains most of its elasticity over a temperature range of between at least 20° C. to 75° C.

8. A method for making an elastomeric device for electrically interconnecting two or more components, comprising the steps of:
embedding a plurality of magnetic particles, coated with a low melting point metal or alloy, in an elastomer by mixing the particles in the elastomer before the elastomer sets;
applying a magnetic field to the particles so that the particles align themselves in electrically isolated columns;
heating the matrix sufficiently to fuse the low melting point coating; and
polymerizing the elastomer to form an elastomeric matrix having one or more outer surfaces and comprising one or more electrically conductive pathways through the matrix.

9. The method of claim 8, wherein the uncured elastomer is coated on a carrier that contains conductive pads.

10. The method of claim 8, wherein the uncured elastomer is coated on a carrier that contains one or more metal layers, the method further comprising the step of creating one or more electrically conductive pads that are electrically continuous with at least one electrically conductive pathway through the matrix.

11. An elastomeric device for electrically interconnecting two or more components, comprising a matrix of electrically insulating elastomer that retains most of its elasticity over a temperature range of at least 20° C. to 75° C., containing an array columns that are electrically conductive liquid over at least the upper range of the use temperature of the device.

12. The device of claim 11, further comprising one or more electrically conductive contact pads in electrical contact with said columns.

13. A method for making an elastomeric device for electrically interconnecting two or more components, comprising the steps of:
creating an array of low melting point metallic columns on a carrier; and
laterally encapsulating said array in an electrically isolating elastomeric matrix.

14. A method for making an elastomeric device for electrically interconnecting two or more components, comprising the steps of:
creating an array of openings in an electrically isolating elastomeric matrix; and
filling the openings with a material that is an electrically conductive liquid over at least the upper range of the use temperature of the device.

15. An elastomeric device for thermally interconnecting two or more components, comprising a matrix of electrically insulating elastomer that retains most of its elasticity over a temperature range of at least 20° C. to 75° C., containing an array of columns that include thermally conductive liquid metal over at least the upper range of the use temperature of the device.
